(19) United States
(12) Patent Application Publication
(10) Pub. No.: US 2023/0121664 A1
(43) Pub. Date: Apr. 20, 2023

(54) LARGE SCALE HYDROPONIC SYSTEM

(71) Applicant: Hydra Unlimited, LLC, Byron Center, MI (US)

(72) Inventor: Daniel N. Campau, Ada, MI (US)

(21) Appl. No.: 17/504,993

(22) Filed: Oct. 19, 2021

(51) Int. Cl. A01G 31/06

(52) U.S. Cl. CPC A01G 31/06; A01G 2031/006

(57) ABSTRACT

The specification discloses a large scale hydroponic system including a plurality of grow tanks interconnected in a subsystem, and a reservoir. The reservoir is connected to the grow tanks through a pump that outputs nutrient fluid through a nutrient supply line. The nutrient supply line is connected to the grow tanks through a subsystem supply line. The subsystem supply line supplies fresh nutrient fluid to each of the grow tanks in the subsystem at substantially the same time. Excess nutrient fluid is exits the grow tanks through an overflow line, which is connected to the reservoir and returns the excess nutrient fluid to the reservoir. A drain line may be connected to the grow tanks to allow the nutrient fluid to be removed from the grow tanks. The drain line is connected to the reservoir and returns the removed nutrient fluid to the reservoir.

### BACKGROUND OF THE INVENTION

The present invention relates to hydroponic systems, and more particularly to large scale hydroponic systems.

Recirculating deep water culture (RDWC) hydroponic systems are widely used. Many growers favor RDWC hydroponic systems because of their speed of plant growth and their size of harvest. In an RDWC system, plants are suspended in grow buckets of liquid nutrient with just their roots in contact with the nutrient. Grow buckets are interconnected by piping and a pump that continuously recirculates the liquid nutrient. RDWC hydroponic systems maintain the same liquid level in all grow buckets. Therefore, the number of buckets that may be serviced by a single pump is limited.

There are two known methods for providing equal liquid levels. The first, and most commonly used, method is a bottom system, such as that manufactured and sold by Current Culture H2O, especially under the UNDER CURRENT® trademark. These systems feature an “epicenter” or reservoir tank, which serves as the nutrient adjustment and mixing tank and usually includes a float valve to maintain a pre-set liquid level. The epicenter tank feeds nutrient solution to one or more rows of growing buckets connected to the epicenter tank by the common pipeline, which is near the bottom of the tanks. The rows of growing buckets are connected together in a chain via large diameter pipe segments. At the end of each row, a pump is provided to draw nutrient solution from the pipeline and return it to the epicenter tank. This design creates a circulation in which nutrient flows from the epicenter tank, progresses from one tank to the next in a sequential or serial order, and then returns to the epicenter tank. Put another way, nutrient passes successively into and out of each bucket near the bottom. The pump draws the nutrient from the end bucket in the chain and pumps it back into the first bucket in the chain, so that there is a continuous recirculation of nutrient through the sequence of grow buckets. This design often includes a system air pump and bubblers in each grow tank to oxygenate the nutrient solution and thereby increase plant growth rate.

In this first method, the rate of flow of the nutrient solution is limited so that all the bucket levels may equalize through the pipe connection. The size of the pump may be determined by the rate of flow limitation, the size of the pipe feeding the chain of grow buckets, and the number of grow buckets. For example, a large system of this type may have four rows of grow buckets with each row of grow buckets containing no more than 12 grow buckets. The interconnecting pipes within each row are joined by headers at each end so that the grow buckets in each row may communicate and maintain the same liquid level. Flow circulates from the epicenter tank into the header feeding the first bucket in each row and progresses into each successive bucket in the row to the end bucket and then into the header from which the pump suction line draws the nutrient and pumps it back into the epicenter. This is a “closed” system, meaning the same nutrient is cycled continuously within the system.

This first method has several disadvantages.

First, these systems generally require a large diameter (2.5″ or more) pipeline to enable nutrient solution circulation and to maintain a common nutrient solution level in the tanks by gravity. Accordingly, labor and material costs are relatively high. Installation and assembly require skill and precision to assure proper leak-free operation. And the tanks become rigidly constrained to each other.

Second, these systems use progressive or sequential circulation, which leads to variation in nutrient solution quality delivered to each bucket. Circulation rate is limited in order to assure gravity equalized tank levels. As a result, plants are not consistently maintained in equal nutrient environments. This manifests itself in roots seeking nutrient and growing into the circulation piping between tanks, potentially partially blocking circulation of nutrient.

Third, in these systems, nutrient concentrations and pH level must be adjusted as plants grow. These adjustments are slow to make in these systems. Chemicals must be added slowly to the epicenter tank to avoid shocking the plants, particularly the plants in the first buckets downstream of the epicenter. This process reduces the time that system operators have for other tasks.

The second method, manufactured and sold by Hydra Unlimited under the HydraMax® trademark, features a circulation system in which nutrient is pumped into each grow bucket through circulators which aspirate air and inject oxygenated nutrient into the grow bucket. Each grow bucket receives the same flow rate of fresh aerated nutrient at the same time, rather than progressively, one bucket after the other as in the first method. The movement of flow out of each bucket is equalized and controlled by a pump and piping network designed to balance the amount of flow out of each bucket, maintaining an equal liquid level in the buckets. Like the first method, this is a closed system. This method does not utilize a separate air pump and mixes air and nutrient in a one to one ratio by volume for efficient oxygenation. Systems of this type may have up to 100 grow buckets.

Unfortunately, existing hydroponic systems may not be well suited to very large growing operations that may have thousands of plants. First, the systems of the types described above divide the plants into relatively small, closed groups, which may not be desirable for large scale growing operations. Each closed system requires its own pump and its own nutrients; and a large number of closed systems requires more oversight, nutrient monitoring instrumentation, and labor than desired.

Commercial growing operations tend to use a centralized nutrient system that is typically delivered to the plants in drip systems with the plants growing in rock wool or other inert grow media. These systems have reduced nutrient management costs. RDWC systems have superior plant growth when compared to drip systems, but the cost of known RDWC systems for large scale operations has been undesirably high. While the growth of individual plants is superior in deep water culture compared to drip systems, the cost is undesirably high in operations of this scope.

### SUMMARY OF THE INVENTION

In a first aspect of the present invention, a large scale hydroponic system may include a plurality of grow tanks and a nutrient reservoir. Each of the plurality of grow tanks may include an overflow outlet and a drain outlet. A nutrient supply system may interconnect the nutrient reservoir to each of the plurality of grow tanks in parallel. A nutrient overflow system may interconnect the overflow outlet of each of the grow tanks in parallel with the reservoir. A drain return system may interconnect the drain outlet of each of the grow tanks in parallel with the reservoir.

In a second aspect of the present invention, a large scale hydroponic system may include a plurality of grow tanks and a reservoir containing nutrient fluid. Each grow tank may include a circulator. The grow tanks may be arranged in subsystems of grow tanks that are connected together. A circulation pump may be connected to the reservoir at its inlet and to a nutrient supply line at its outlet. The nutrient supply line may be connected to at least one subsystem supply line. The subsystem supply line may be connected to a plurality of circulator supply lines, which each may be connected to the circulator of one of the grow tanks. Pressurized nutrient fluid may flow from the circulation pump through the nutrient supply line, into the subsystem supply line, and to the circulator supply lines. The circulator may aerate the nutrient fluid and inject the aerated nutrient fluid into the grow tank. The nutrient fluid may be provided to each of the grow tanks in the subsystem at substantially the same time.

An overflow line may be fluidly connected to the reservoir and to at least one subsystem overflow line. Tank overflow lines may connect each grow tank in a subsystem to the subsystem overflow line. Nutrient fluid may flow out of the grow tanks through the tank overflow lines, the subsystem overflow line, and the overflow line into the reservoir.

In a first refinement of the present invention, a drain line may be fluidly connected to the reservoir. A plurality of tank drain lines may connect each of the grow tanks to a subsystem drain line, which in turn may be connected to the drain line. A plurality of valves may be connected between the grow tank and the subsystem drain line. When the valve is in an open position, the nutrient fluid may drain from the corresponding grow tank and into the reservoir. In one aspect, each of the plurality of valves is normally in a closed position.

In a second refinement of the present invention, a subsystem drain line may be fluidly connected to the reservoir. A plurality of tank drain lines may each connect one of the grow tanks to the subsystem drain line. A valve between the subsystem drain line and the reservoir may regulate the flow of nutrient fluid between the subsystem drain line and the reservoir. When the valve is in an open position, the nutrient fluid may drain from each of the grow tanks in the subsystem.

In a third aspect of the present invention, the subsystem overflow lines may be fluidly connected to an overflow receptacle. An overflow pump may be connected to the overflow receptacle at the overflow pump's inlet and to an overflow line at the pump's outlet. The overflow pump may transfer the nutrient fluid from the overflow receptacle through the overflow line to the reservoir.

These and other advantages and features of the invention will be more fully understood and appreciated by reference to the description of the current aspects and the drawings.

### BRIEF DESCRIPTION OF THE DRAWINGS

FIG. 1 is a perspective view of a large scale hydroponic system according to one aspect.

FIG. 2 is a top perspective view of a grow bucket and its plumbing for use in a large scale hydroponic system according to one aspect.

FIG. 3 is a side view of the grow bucket and its plumbing of FIG. 2.

FIG. 4 is a top view of the grow bucket and its plumbing of FIG. 2.

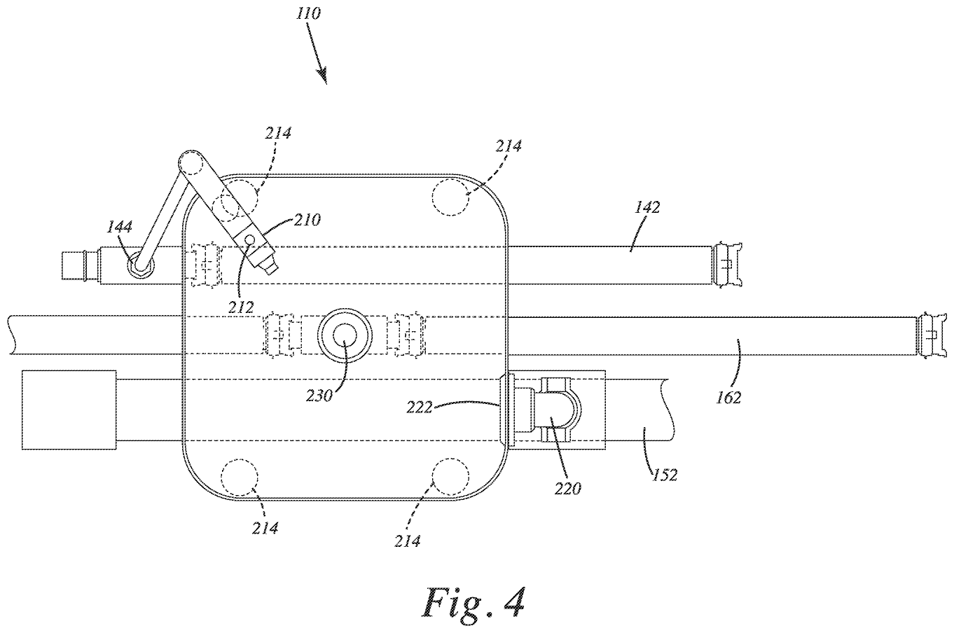

FIG. 5 is a front view of a large scale hydroponic system according to one aspect.

FIG. 6 is a top view of a portion of a large scale hydroponic system according to one aspect.

FIG. 7 is a back view of the portion of a large scale hydroponic system of FIG. 6.

FIG. 8 is a front view of a large scale hydroponic system according to one aspect.

### DESCRIPTION OF THE CURRENT ASPECTS

Various aspects of a large scale hydroponic system including a reservoir and subsystems of grow buckets are shown and described herein.

Before the aspects of the invention are explained in detail, it is to be understood that the invention is not limited to the details of operation or to the details of construction and the arrangement of the components set forth in the following description or illustrated in the drawings. The invention may be implemented in various other aspects and of being practiced or being carried out in alternative ways not expressly disclosed herein. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof. Further, enumeration may be used in the description of various aspects. Unless otherwise expressly stated, the use of enumeration should not be construed as limiting the invention to any specific order or number of components. Nor should the use of enumeration be construed as excluding from the scope of the invention any additional steps or components that might be combined with or into the enumerated steps or components. Any reference to claim elements as “at least one of X, Y and Z” is meant to include any one of X, Y or Z individually, and any combination of X, Y and Z, for example, X, Y, Z; X, Y; X, Z; and Y, Z.

A large scale RDWC hydroponic system is shown and described. In one aspect, the system may include a network of circulators for each grow bucket. The grow buckets may alternately be referred to as grow tanks. The circulators may aerate and inject fresh nutrient substantially simultaneously into each grow bucket. At the same time, the system may drain an equal amount of nutrient from each grow bucket and returns it to the central reservoir. The system may be described as an “open” system because it includes a centrally maintained nutrient, common to all grow buckets, independent of the number of grow buckets in the system. The system may reduce nutrient management costs, simplify plumbing, and uniformly nourish all plants. Individual rows of plants may be excluded or included in the recirculating circuit. This gives an operator the ability to operate the facility at full or partial capacity. It also may give the operator the ability to easily place additional grow buckets into service without interrupting the operation of existing grow buckets. The system allows RDWC to be functional and practical for large scale hydroponic agriculture.

In one aspect, a large scale hydroponic system may include a plurality of grow tanks and a nutrient reservoir. Each of the plurality of grow tanks may include an overflow outlet and a drain outlet. A nutrient supply system may interconnect the nutrient reservoir to each of the plurality of grow tanks in parallel. A nutrient overflow system may interconnect the overflow outlet of each of the grow tanks in parallel with the reservoir. A drain return system may interconnect the drain outlet of each of the grow tanks in parallel with the reservoir.

All of the connections described herein allow for fluid communication.

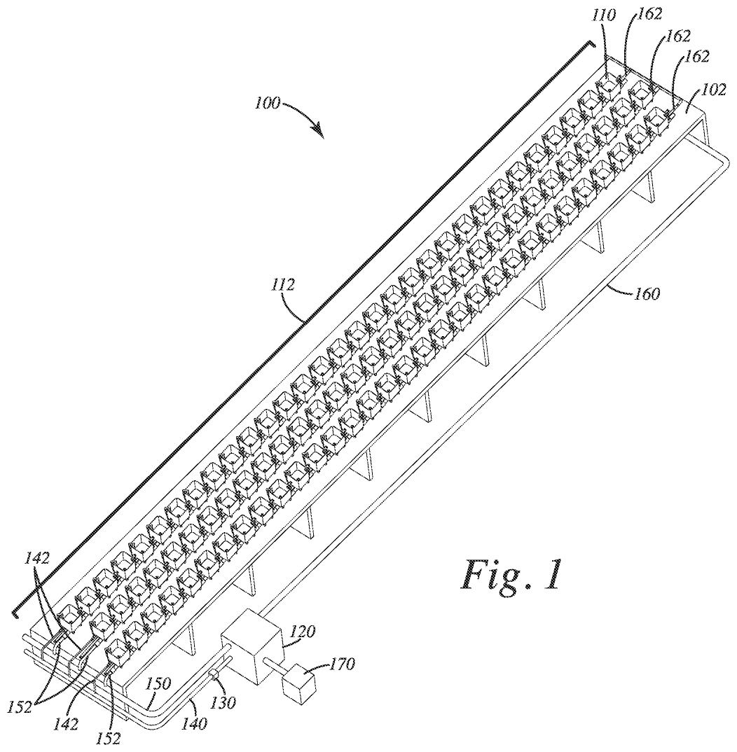

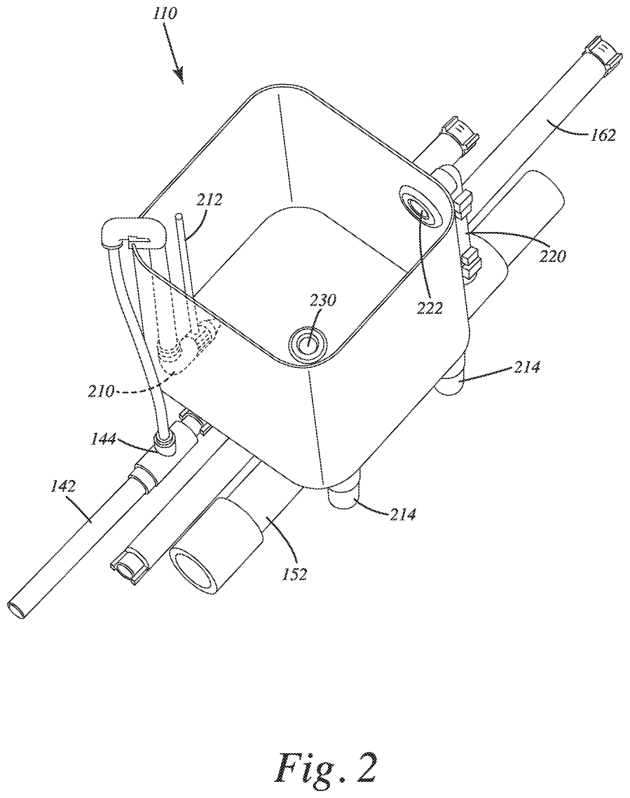

In FIG. 1, a large scale hydroponic system 100 according to one aspect is shown. The hydroponic system 100 may include a plurality of grow tanks 110. The grow tanks 110 may alternately be referred to as grow buckets. Each grow tank 110 may contain one plant. The grow tanks 110 may be arranged in rows and the grow tanks 110 in each row may be interconnected through a system of pipes as shown and described in more detail with reference to FIG. 2. In one aspect, connecting the grow tanks 110 in rows as needed may create groups of plants that mature at progressive intervals to provide continuous harvesting. Put another way, planting the plants one row at a time may allow each row of plants to mature at a different time from the other rows to provide continuous harvesting. Each row of grow tanks 110 may be referred to as a subsystem, for example, subsystem 112.

As shown in FIG. 1, the system 100 may include a grow table 102 on which the grow tanks 110 and their associated plumbing may be placed and/or arranged. In one aspect, more than one grow table 102 may be connected in series to create larger subsystems 112. The liquid level in each grow tank 110 in the subsystem 112 may be maintained at substantially the same level as all of the other grow tanks 110 in the subsystem 112. In one aspect, the liquid level in each of the grow tanks 110 in the subsystem 112 may be within half an inch of the liquid level in the other grow tanks 110 in the subsystem 112. The system 100 may include a reservoir 120. The reservoir 120 may provide a central location where nutrient concentrations may be monitored and controlled. The reservoir 120 may contain an amount of a nutrient fluid. The reservoir 120 may have a different level of nutrient fluid than the level of nutrient fluid in the grow tanks 110. In one aspect, a nutrient supply 170 may be connected to the reservoir 120. The nutrient supply 170 may be continuously or periodically added to the reservoir 120 either manually or automatically. A circulation pump 130 may be connected to the reservoir 120 at its inlet. The outlet of the circulation pump 130 may be connected to a nutrient supply line 140. In one aspect, a circulator valve (not shown) may be at the outlet of the circulation pump 130. When the circulator valve is in a closed position, the circulator valve may prevent the flow of nutrient fluid between the reservoir 120 and the grow tanks 110. In one aspect, the circulator valve in the closed position may prevent the flow of nutrient fluid between the reservoir 120 and the nutrient supply line 140 even if the level of nutrient fluid in the reservoir 120 and in the grow tanks 110 are different. When the circulator valve is in an open position, nutrient fluid may flow from the reservoir 120 to the nutrient supply line 140 through the circulation pump 130.

A plurality of subsystem supply lines 142 may branch off of the nutrient supply line 140 to carry the nutrient fluid to the grow tanks 110. The subsystem supply lines 142 may alternately be referred to as subsystem nutrient supply lines or circulator supply lines. The subsystem supply line 142 may supply fresh nutrient to each grow tank 110 in its subsystem. The nutrient fluid that flows through the nutrient supply line 140 may be pressurized. In one aspect, the subsystem supply lines 142 and the nutrient supply line 140 may form one integral component.

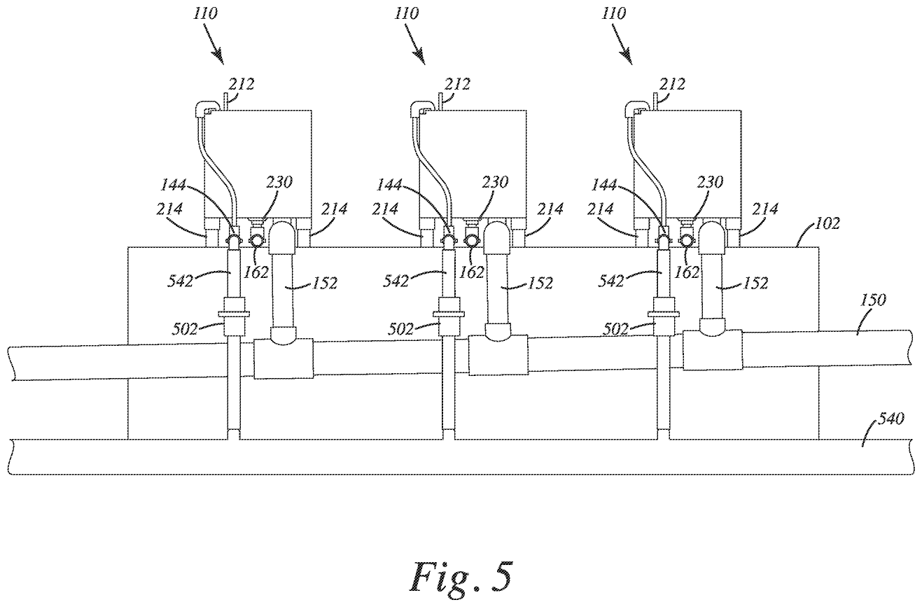

In one aspect, a subsystem supply line 542 and a nutrient supply line 540 may be connected through a subsystem nutrient supply valve 502 as shown in FIG. 5. When the subsystem nutrient supply valve 502 is in the open position, nutrient fluid may flow from the nutrient supply line 540 to the subsystem supply line 542. When the subsystem nutrient supply valve 502 is in the closed position, nutrient fluid may be prevented from entering the subsystem supply line 542 from the nutrient supply line 540. In one aspect, the subsystem nutrient supply valve 502 may be in the normally open position. In one aspect, the subsystem nutrient supply valve 502 may be used to adjust the pressure of the nutrient fluid flowing to the grow tanks 110.

FIG. 2 shows a single grow bucket 110 and its plumbing according to one aspect. In one aspect, the grow tanks 110 may have at least one leg 214 extending from a bottom surface of the grow tank 110 that defines a space below the grow tank 110 to allow the plumbing to run underneath the grow tank 110. The subsystem supply line 142 may be connected to a plurality of circulator supply lines 144. There may be one circulator supply line 144 for each grow bucket 110. As shown in FIG. 2, each circulator supply line 144 may be connected to a circulator 210. The circulator 210 may aerate the nutrient fluid and inject the aerated nutrient fluid into the grow tank 110. As shown in FIG. 2, the circulator 210 may aerate the nutrient fluid by way of a snorkel 212. The circulator 210 may be mounted to a wall of the grow tank 110. As shown in FIG. 2, the circulator 210 may be mounted in a corner of the grow tank 110. As shown in FIG. 2, in one aspect, the circulator 210 may be configured to inject the aerated nutrient fluid near the bottom of the grow tank 110. In an alternate aspect, the circulator 210 may inject the aerated nutrient fluid at any other suitable location of the grow tank 110. In an alternate aspect, the circulator supply line 144 may be directly connected to the grow tank 110.

In one aspect, each of the circulator supply lines 144 may be connected to the subsystem supply line 142 through a circulator supply valve. The circulator supply valve may restrict the flow of nutrient fluid from the subsystem supply line 142 to the circulator supply lines 144. Put another way, the circulator supply valve may restrict the flow of nutrient fluid to the grow tank 110. When in the open position, the circulator supply valve may permit the flow of nutrient fluid from the subsystem supply line 142 to the circulator supply line 144. When in the closed position, the circulator supply valve may restrict the flow of nutrient fluid from the subsystem supply line 142 to the circulator supply line 144. In one aspect, the circulator supply valves may be in the normally open position.

Returning to FIG. 1, an overflow line 150 may be connected to the reservoir 120. A subsystem overflow line 152 may branch off of the overflow line. The subsystem overflow line 152 may carry the excess nutrient fluid removed from each grow tank 110 to the overflow line 150 where it is returned to the reservoir 120. The size of the subsystem overflow line 152 may vary in size depending on the number of grow tanks 110 in the subsystem 112. For example, a two inch subsystem overflow line 152 may be used with a subsystem 112 containing 30 grow tanks 110. In one aspect, placing the grow tanks 110 on the grow table 102 elevates the grow tanks 110 with respect to the reservoir 120, which may allow for easier flow of the nutrient fluid in the overflow line 150 and a drain line 160 (described in more detail below) due to the force of gravity. In one aspect, as shown in FIG. 5, the overflow line may be angled with respect to the ground plane to ease movement of the nutrient fluid from the grow tanks 110 to the reservoir 120.

As shown in FIG. 2, a tank overflow line 220 may be connected to the subsystem overflow line 152. The overflow assembly may be mounted to the sidewall of the grow tank 110 at the desired liquid level. The tank overflow line 220 may be in fluid communication with the nutrient fluid in the grow tank 110 through a port 222 in one side of the grow tank 110. In one aspect, as the nutrient fluid flows into the grow tank 110 an equal amount of nutrient fluid may be removed from the grow tank 110 through the tank overflow line 220 and returned to the reservoir 120. In one aspect, the amount of nutrient fluid removed from the grow tank 110 may depend on the level of nutrient fluid already present in the grow tank 110. For example, if the amount of nutrient fluid added to the grow tank 110 and the amount of fluid already present in the grow tank 110 when combined does not rise to the height of the port 222, no nutrient fluid will be removed from the grow tank 110.

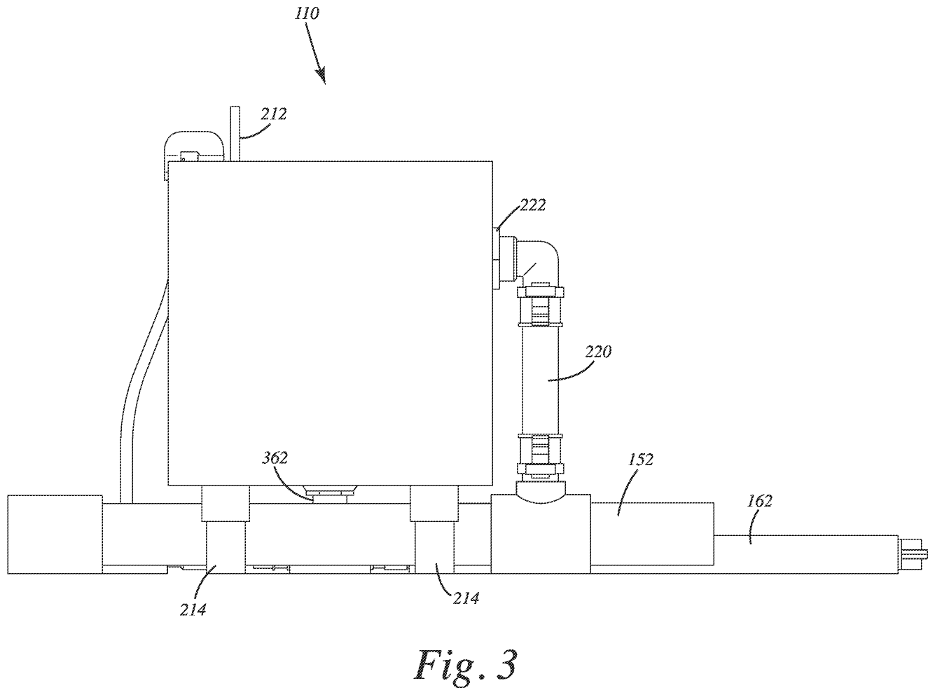

As shown in FIG. 1, the hydroponic system 100 may include a drain line 160. The drain line 160 may be fluidly connected to one or more subsystem drain lines 162 and the reservoir 120. In one aspect, the subsystem drain line 162 may assist in keeping a uniform flow rate across all of the circulators 210 in a subsystem 112. In one aspect, the subsystem drain line 162 may help to keep a substantially uniform nutrient fluid level in each of the grow tanks 110 in the subsystem 112. In one aspect, the subsystem drain line 162 may help to keep uniform aeration across all the grow tanks 110 in the subsystem 112. In one aspect, the subsystem drain line 162 may assist in creating a uniform recirculation rate to all grow tanks in the subsystem 112. In one aspect, the nutrient fluid may move through the drain line 160 using the force of gravity. The subsystem drain line 162 may be connected to at least one tank drain lines 362 for each grow tank 110 as seen in FIG. 3. As shown in FIG. 2, the tank drain line 362 may be in fluid communication with its corresponding grow tank 110 through a drain port 230. Each drain port 230 may contain or be in connection with a valve. When the valve is open, the nutrient fluid may flow out of the grow tank 110 and into the subsystem drain line 162 and drain line 160. When the valve is closed, the nutrient fluid may only leave the grow tank 110 through the subsystem overflow line 152. In one aspect, the valves may be in a normally closed position. The drain line 160 may allow the fluid to be drained from each of the grow tanks 110 individually or as a subsystem. This allows individual grow tanks 110 or subsystems of grow tanks 112 to be added to or removed from the hydroponic system 100 as needed without impacting the other grow tanks 110 or subsystems in the system 100. In one aspect, the fluid may be drained from the grow tanks 110 to facilitate cleaning the grow tanks 110 between growing cycles. In one aspect, the subsystem drain line 162 may allow a more powerful circulator 210 with a higher flow rate to be used in the system by draining more nutrient fluid from each of the grow tanks than may be removed by the subsystem overflow line 152.

In one aspect, a drain line valve may be installed between each subsystem drain line 162 and the drain line 160. When the drain line valve is in the closed position, the nutrient fluid may be maintained in the grow tanks 110 through the subsystem supply lines 142 and subsystem overflow lines 152. When the drain line valve is in the open position, the nutrient fluid in all of the grow tanks 110 in the subsystem 112 may leave the grow tanks 110 and return to the reservoir 120 through the drain line 160. In one aspect, the drain line valve may be in a normally closed position.

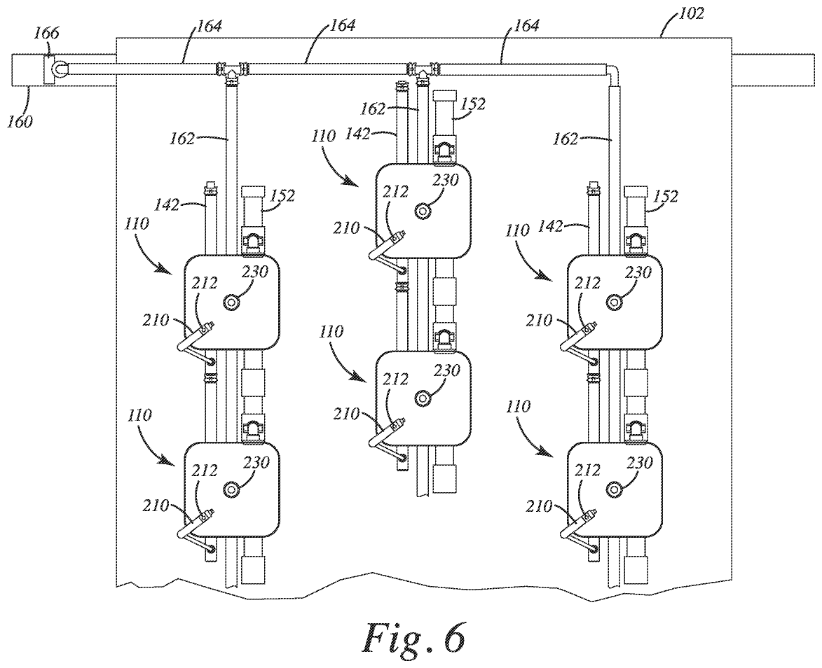

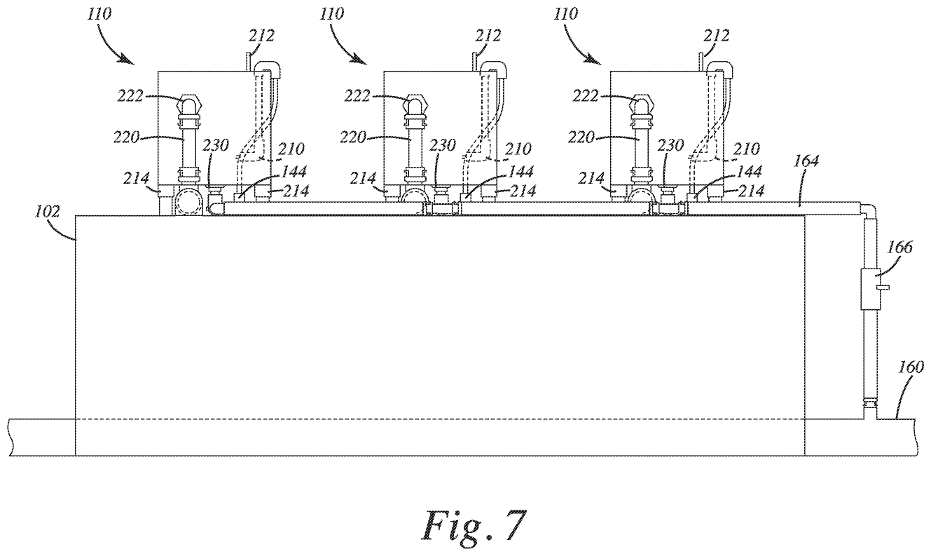

FIG. 6 shows a portion of a large scale hydroponic system according to one aspect. As shown in FIG. 6, in one aspect, the subsystem drain lines 162 may connect to a grow table drain line 164. The grow table drain line 164 may be connected to the drain line 160. A drain line shut-off valve 166 may be installed between the grow table drain line 164 and the drain line 160. When the drain line shut-off valve 166 is closed, it may prevent nutrient fluid from exiting the grow tanks 110. When the drain line shut-off valve 166 is open, it may allow the nutrient fluid to exit the grow tanks 110 and return to the reservoir 120. In one aspect, the drain line shut-off valve 166 may normally be in the closed position. FIG. 7 shows a back view of FIG. 6. In FIG. 7, the drain line 160 is shown running underneath the grow table 102. In one aspect, the drain line 160 may be sloped to facilitate flow of the nutrient fluid to the reservoir 120. The drain line 160 is preferably located at the opposite end of the grow table 102 from the nutrient supply line 140 and the overflow line 150. As shown in FIG. 6, the subsystem supply lines 142 and the subsystem overflow lines 152 are closed at the end of the grow table with the drain line 160. This may prevent the drain line 160 from crossing over any other pipe lines.

In one aspect, all or a portion of the plumbing of the grow tank 110 is designed to be modular. The grow tank 110 may be attached to a portion of the subsystem supply line 142 and the subsystem overflow line 152. These portions may be attached to the subsystem supply line 142 and the subsystem overflow line 152 of another grow tank 110 to form a subsystem. The grow tank 110 may be connected to the drain line 160 through a port in the bottom of the grow tank 110. The drain line 160 may also be modular.

In one aspect, there may be more than one subsystem of grow tanks 110 in the hydroponic system 100. As shown in FIG. 1, there are three subsystems of grow tanks 110. Each subsystem may have its own plumbing as described above with reference to the subsystem 112. Each subsystem may receive nutrient fluid from the supply line 140, move nutrient fluid to the overflow line 150, and drain nutrient fluid to the drain line independently from all other subsystems. As shown in FIG. 1, the grow tanks 110 in each subsystem are arranged in a straight line on the grow table 102. In an alternate aspect, the grow tanks 110 in each subsystem may be arranged in any suitable orientation.

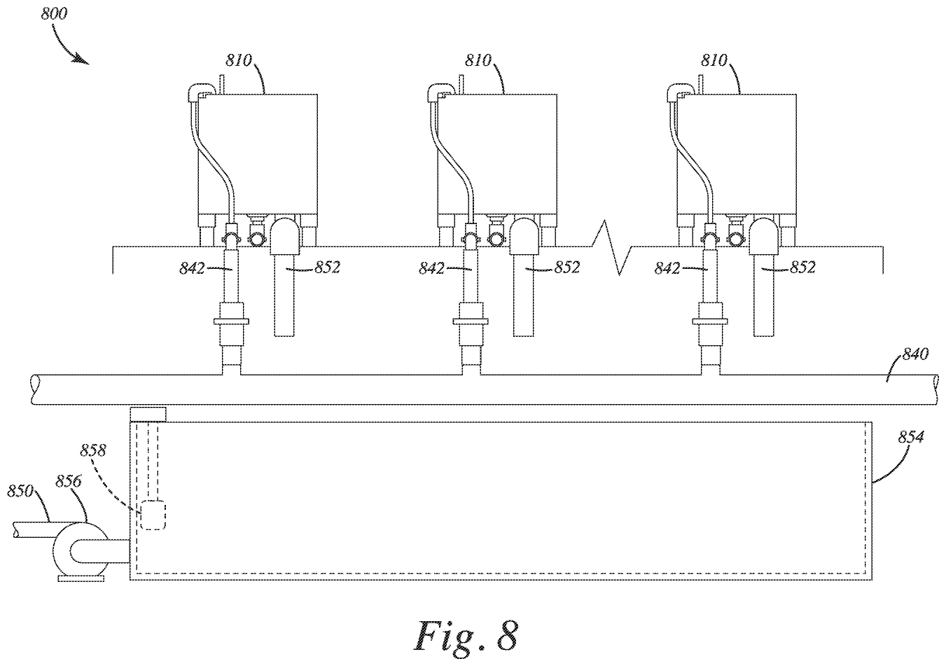

In FIG. 8, a front view of a hydroponic system 800 according to one aspect is shown. The hydroponic system 800 may have a plurality of grow tanks 810. Each grow tank 810 may be connected to a subsystem supply line 842 which, in turn, may be connected to a nutrient supply line 840. Each grow tank 810 may be connected to a subsystem overflow line 852. As shown in FIG. 8, the subsystem drain line 862 may terminate in an open end over an overflow receptacle 854. The overflow receptacle may collect the overflow from one or more subsystems. In one aspect, the subsystem drain line 82 may be coupled to the overflow receptacle 854. In one aspect, the subsystem drain lines 82 may join to a receptacle drain line (not shown) that may output the nutrient fluid into the overflow receptacle 854. An overflow pump 856 may have an outlet and an inlet. The inlet of the overflow pump 856 may be connected to the overflow receptacle 854. The outlet of the overflow pump 856 may be connected to the overflow line 850. When the overflow pump 856 is running, the overflow pump 856 may transfer the nutrient fluid from the overflow receptacle 854 to the reservoir (not shown) through the overflow line 850. If the number of grow tanks in the system is increased to the point where the inflow is above the design limit of the overflow pump 856, the size of the overflow pump 856 may be increased.

As shown in FIG. 8, there may optionally be a level switch 858 in the overflow receptacle 854. The level switch 858 may start in a position that blocks the inlet of the overflow pump 856. As nutrient fluid enters the overflow receptacle 854, it may lift the level switch 858 toward the top of the overflow receptacle 854. When a sufficient amount of nutrient fluid enters the overflow receptacle 854 (put another way, the nutrient fluid reaches a preset point), the level switch 858 may be raised enough that it does not obstruct the inlet of the overflow pump 856 and the overflow pump 856 may turn on. As the overflow pump 856 removes the nutrient fluid from the overflow receptacle 854, the level switch 858 may be lowered until it covers the inlet of the overflow pump 856. When the level switch 858 covers the inlet of the overflow pump 856, the overflow pump 856 may turn off. In one aspect, the overflow pump 856 may be sized to maintain a flow rate equal to or greater than the inflow rate from the subsystem overflow lines 852. In one aspect, the size of the overflow pump 856 may be selected based on the inflow rate from the subsystem overflow lines 852 and the pressure drop in the overflow line 850 returning the nutrient fluid to the reservoir.

An exemplary large scale hydroponic system is now described. The flow rate of nutrient fluid both into and out of each grow tank 110 may be of 0.7 gallons per minute (“GPM”) or 42 gallons per hour (“GPH”). The nutrient fluid may be supplied through the nutrient supply line 140 at a supply pressure of 5 pounds per square inch (“PSI”). At that supply pressure, each circulator may consume 0.002 horsepower. For a large scale hydroponic system with 2500 grow tanks, the total power consumption by the circulators may be 5 horsepower. The exemplary large scale hydroponic system may be supplied by one or more large capacity pumps. If one large pump is used, its output may be connected to a manifold and nutrient supply lines may be routed from the manifold to individual grow tables. If multiple pumps are used, pump inlets may be independently connected to the reservoir and their outputs may be connected to individual grow tables without the need to feed a common output manifold. This may maximize the performance of each pump and eliminate the potential problems of balancing multiple pumps feeding the same manifold.

In one aspect, the grow tables may each support multiple rows (subsystems) with 15 or 16 buckets each. If the exemplary system utilizes an overflow receptacle, the total circulation rate for a 2500 grow tank system may be 1750 GPM. In one aspect, the system may utilize more than one overflow receptacle and more than one overflow pump to reduce pipeline pressure drops. This may reduce the size of overflow pump required.

Directional terms, such as “vertical,” “horizontal,” “top,” “bottom,” “upper,” “lower,” “inner,” “inwardly,” “outer” and “outwardly,” are used to assist in describing the invention based on the orientation of the aspects shown in the illustrations. The use of directional terms should not be interpreted to limit the invention to any specific orientation(s).

The above description is that of current aspects of the invention. Various alterations and changes may be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all aspects of the invention or to limit the scope of the claims to the specific elements illustrated or described in connection with these aspects. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed aspects include a plurality of features that are described in concert and that might cooperatively provide a collection of benefits. The present invention is not limited to only those aspects that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular.

The aspects of the invention in which an exclusive property or privilege is claimed are defined as follows:

1. A hydroponic system comprising:
a plurality of grow tanks each including an overflow outlet and a drain outlet;
a nutrient reservoir;
a nutrient supply system interconnecting the nutrient reservoir to each of the plurality of grow tanks in parallel;
a nutrient overflow return system interconnecting the overflow outlet of each of the grow tanks in parallel with the reservoir; and
a drain return system interconnecting the drain outlet of each of the grow tanks in parallel with the reservoir.

2. The hydroponic system of claim 1,
wherein the plurality of grow tanks includes a first subsystem of grow tanks and a second subsystem of grow tanks,
wherein the nutrient supply system connects the reservoir to the first subsystem of grow tanks and the second subsystem of grow tanks independently of each other,
wherein the nutrient overflow system connects the overflow outlets of the first subsystem of grow tanks to the reservoir independently of the overflow outlets of the second subsystem of grow tanks, and
wherein the drain return system connects the drain outlets of the first subsystem of grow tanks to the reservoir independently of the overflow outlets of the second subsystem of grow tanks.

3. The hydroponic system of claim 1, comprising:
each of the plurality of grow tanks including a drain valve, the drain valve having an open position and a closed position,
wherein fluid flows from the grow tank through the drain return system to the reservoir when the drain valve is in the open position, and wherein fluid is retained in the grow tank when the drain valve is in the closed position.

4. The hydroponic system of claim 3, wherein each of the drain valves is normally in the closed position.

5. The hydroponic system of claim 1, comprising:
the nutrient overflow system including an overflow receptacle and an overflow pump, the overflow pump having an inlet connected to the overflow receptacle and an outlet connected to the reservoir,
wherein the overflow receptacle is configured to receive the nutrient overflow from the plurality of grow tanks, and
wherein the overflow pump pumps the nutrient overflow from the overflow receptacle back to the reservoir.

6. The hydroponic system of claim 5, comprising a level switch, wherein the level switch causes the overflow pump to turn on when the amount of the nutrient overflow in the overflow receptacle reaches a first predetermined level, and wherein the level switch causes the overflow pump to turn off when the amount of the nutrient fluid in the overflow receptacle reaches a second predetermined level.

7. A hydroponic system comprising:
a first plurality of grow tanks, each of the grow tanks including a circulator;
a reservoir, the reservoir containing an amount of a nutrient fluid;
a circulation pump having an inlet and an outlet, the inlet fluidly connected to the reservoir;
a nutrient supply line fluidly connected to the outlet of the circulation pump;
a first subsystem supply line fluidly connected to the nutrient supply line;
a first plurality of circulator supply lines each fluidly connecting the first subsystem supply line to the circulator for one of the grow tanks of the first plurality of grow tanks;
an overflow line fluidly connected to the reservoir;
a first subsystem overflow line fluidly connected to the overflow line; and
a first plurality of tank overflow lines each fluidly connecting the first subsystem overflow line to one of the grow tanks of the first plurality of grow tanks,
wherein each of the circulators aerates the nutrient fluid received from the circulator supply line and injects the aerated nutrient fluid into the grow tank.

8. The hydroponic system of claim 7, comprising:
a second plurality of grow tanks, each of the grow tanks including a circulator;
a second subsystem supply line fluidly connected to the nutrient supply line;
a second plurality of circulator supply lines each fluidly connecting the second subsystem supply line to the circulator of one of the grow tanks of the second plurality of grow tanks;
a second subsystem overflow line fluidly connected to the overflow line; and
a second plurality of tank overflow lines each fluidly connecting one of the grow tanks of the second plurality of grow tanks to the second subsystem overflow line,
wherein each of the circulators connected to one of the grow tanks in the second plurality of grow tanks aerates the nutrient fluid received from the circulator supply line and injects the aerated nutrient fluid into the grow tank, and
wherein the first plurality of grow tanks and the second plurality of grow tanks receive nutrient fluid from the nutrient supply line independent of each other.

9. The hydroponic system of claim 7, comprising:
a drain line fluidly connected to the reservoir;
a first subsystem drain line fluidly connected to the drain line;
a first plurality of tank drain lines each fluidly connecting one of the grow tanks of the first plurality of grow tanks to the first subsystem drain line; and
a first plurality of valves each regulating the flow of the nutrient fluid between one of the grow tanks of the first plurality of grow tanks to the first subsystem drain line,
wherein the nutrient fluid drains from one of the grow tanks of the first plurality of grow tanks when the corresponding valve is in an open position.

10. The hydroponic system of claim 9, wherein each of the first plurality of valves are normally in a closed position.

11. The hydroponic system of claim 7, comprising:
a first subsystem drain line fluidly connected to the reservoir;
a first plurality of tank drain lines each fluidly connecting one of the grow tanks of the first plurality of grow tanks to the first subsystem drain line; and
a valve regulating the flow of the nutrient fluid between the first subsystem drain line and the reservoir,
wherein the nutrient fluid drains from each of the grow tanks in the first plurality of grow tanks when the valve is in an open position.

12. The hydroponic system of claim 7, comprising a nutrient supply fluidly connected to the reservoir.

13. The hydroponic system of claim 7, wherein the nutrient supply line and the first subsystem supply line are one component.

14. The hydroponic system of claim 7, comprising a first subsystem nutrient control valve regulating the flow of the nutrient fluid between the nutrient supply line and the first subsystem supply line, wherein the nutrient fluid is prevented from entering the first subsystem supply line when the first subsystem nutrient control valve is in a closed position.

15. The hydroponic system of claim 7, comprising a first plurality of circulator supply valves each regulating the flow of the nutrient fluid between each of the first plurality of circulator supply lines and the subsystem supply line, wherein the nutrient fluid is prevented from entering each of the first plurality of circulator supply lines when each of the first plurality of circulator supply valves is in the closed position.

16. The hydroponic system of claim 7, wherein a first amount of the nutrient fluid received in each of the grow tanks in the first plurality of grow tanks through the circulator supply line is equal to a second amount of the nutrient fluid removed from each of the grow tanks in the first plurality of grow tanks through each of the first plurality of tank overflow lines.

17. The hydroponic system of claim 7, wherein the overflow line is sloped with respect to a ground plane to facilitate the flow of nutrient fluid to the reservoir.

18. A hydroponic system comprising:
a first plurality of grow tanks, each grow tank including a circulator;
a reservoir the reservoir containing an amount of a nutrient fluid;
a circulation pump having an inlet and an outlet, the inlet fluidly connected to the reservoir;
a nutrient supply line fluidly connected to the outlet of the circulation pump;
a first subsystem supply line fluidly connected to the nutrient supply line;
a first plurality of circulator supply lines each fluidly connecting the first subsystem supply line to the circulator of one of the grow tanks of the first plurality of grow tanks;
a first plurality of tank overflow lines each fluidly connected to one of the grow tanks of the first plurality of grow tanks;
a first subsystem overflow line fluidly connected to each of the first plurality of tank overflow lines;
an overflow receptacle fluidly connected to the first subsystem overflow line, the overflow receptacle having an outlet;
an overflow pump having an inlet and an outlet, the inlet fluidly connected to the outlet of the overflow receptacle; and
an overflow line fluidly connected to the outlet of the overflow pump and the reservoir,
wherein each of the circulators aerates the nutrient fluid received from the circulator supply line and injects the aerated nutrient fluid into the grow tank, and
wherein the overflow pump transfers the nutrient fluid from the overflow receptacle through the overflow line and into the reservoir.

19. The hydroponic system of claim 18, comprising a level switch, wherein the level switch causes the overflow pump to turn on when the amount of the nutrient fluid in the overflow receptacle reaches a first predetermined level, and wherein the level switch causes the overflow pump to turn off when the amount of the nutrient fluid in the overflow receptacle reaches a second predetermined level.

20. The hydroponic system of claim 18, comprising:
a circulator valve, the circulator valve connecting the outlet of the circulation pump to the nutrient supply line,
wherein the circulator valve allows nutrient fluid to flow from the circulation pump to the nutrient supply line when the circulator valve is in an open position, and
wherein the circulator valve prevents nutrient fluid from flowing between the circulation pump and the nutrient supply line when the circulator valve is in a closed position.
